(19) United States
(12) Patent Application Publication
(10) Pub. No.: US 2025/0202372 A1
(43) Pub. Date: Jun. 19, 2025

(54) ISOLATED RESONANT DC-DC CONVERTER

(71) Applicant: Delta Electronics, Inc., Taipei (TW)

(72) Inventors: Yuri Panov, Durham, NC (US); Peter Mantovanelli Barbosa, Durham, NC (US); Yi-Hua Chang, Taoyuan City (TW); Kai Dong, Shanghai (CN)

(21) Appl. No.: 19/064,639

(22) Filed: Feb. 26, 2025

Related U.S. Application Data
(63) Continuation-in-part of application No. 18/242,797, filed on Sep. 6, 2023, now Pat. No. 12,267,020.
Application No. 18/242,797 is a division of application No. 17/482,981, filed on Sep. 23, 2021, now Pat. No. 11,791,733.

(51) Int. Cl. H02M 3/335; H02M 1/00; H02M 1/08; H02M 1/14; H02M 3/00

(52) U.S. Cl. CPC H02M 3/33573; H02M 1/0009; H02M 1/08; H02M 1/14; H02M 3/01; H02M 3/33571

(57) ABSTRACT

An isolated DC-DC converter is provided, including a full-bridge switching stage, a resonant network, a transformer, an output stage, an output stage, an error amplifier, a feedforward controller, a charge sensor and a switch controller. The output stage generates an output signal, wherein the output signal is an output voltage or output current. The error amplifier generates an error signal based on the output signal and a reference signal, wherein the reference signal is a reference voltage or reference current. The feedforward controller senses an input voltage of the full bridge switching stage, and generates a feedforward control signal based on the sensed signal. The charge sensor generates at least one charge sensing signal. The switch controller generates and provides switch control signals to the plurality of active switches in charge control mode based on at least the error signal, the feedforward control signal and the charge sensing signal.

### CROSS-REFERENCE TO RELATED APPLICATION

This application is a Continuation-in-Part Application of U.S. patent application Ser. No. 18/242,797 filed on Sep. 6, 2023 and entitled “ISOLATED RESONANT DC-DC CONVERTER”, which is a Divisional Application of U.S. patent application Ser. No. 17/482,981 filed on Sep. 23, 2021, issued on Oct. 17, 2023 as U.S. Pat. No. 11,791,733 and entitled “ISOLATED RESONANT DC-DC CONVERTERS AND CONTROL METHODS THEREOF”. The entire contents of the above-mentioned patent applications are incorporated herein by reference for all purposes.

### FIELD OF THE INVENTION

The present disclosure relates to an isolated resonant DC-DC power converter. More particularly, the present disclosure relates to an isolated DC-DC resonant power converters for improving transient response and suppressing low-frequency output voltage ripple.

### BACKGROUND OF THE INVENTION

Generally, switching-mode resonant DC-DC converters have low switching losses of their switches and, therefore, can operate very efficiently at high frequency that also allows size reduction of their magnetic components and capacitors. Today, resonant isolated DC-DC converters are widely used in many applications which require high efficiency and isolation between the input and output ports of the converter. As shown in FIG. 1, the isolated resonant DC-DC converter includes a primary switching stage, a primary resonant circuit, a transformer TR, a secondary resonant circuit, a secondary switching stage, and an output filter. The most common implementations of the primary switching stage are full-bridge chopper and half-bridge chopper. The most common implementations of the primary resonant network are LC network, LLC network, and CLC network. Secondary resonant network is typically employed in CLLC bidirectional resonant converters. Refs. [1]-[3]. Most common implementations of secondary switching stage are full-bridge stage, center-tapped stage, or voltage-doubler stage.

FIG. 2 is a circuit diagram of a conventional DC-DC LLC resonant power converter. Its primary switching stage includes a full-bridge circuit comprised of MOSFET switches S1-S4. Its primary resonant network includes inductors L_{R}, L_{M}, and capacitor C_{R}. For unidirectional power transfer, the LLC converter in FIG. 2 does not require a secondary resonant stage and its secondary switching stage includes diodes D1-D4. Its output CLC filter includes inductance L_{O} and capacitors C_{O1} and C_{O2}.

FIG. 3 is a block diagram of a conventional full-bridge LLC resonant DC-DC converter with the direct frequency control (DFC). So far, DFC is the most popular and mature control method for resonant converters, where output voltage regulation is achieved by directly varying switching frequency. As shown in FIG. 3, voltage sensor senses and scales output voltage V_{O} and the sensor output voltage is compared to reference voltage V_{REF}. The difference between voltage V_{REF} and sensed output voltage is processed by error amplifier (EA). EA output voltage V_{EA} is applied to the input of voltage-controlled oscillator (VCO), whose output is a square-wave pulse train of the frequency determined by voltage V_{EA}. Switch control circuit in FIG. 3 produces driving signals for switches S1-S4, which operate with the same nearly 50% duty cycle. For a full-bridge primary switching network, driving signals of switches S1, S4 are the same, as well as driving signals of switches S2, S3. As can be seen from FIG. 3, DFC is essentially a single-loop feedback control.

However, DFC control-to-output transfer function G_{VC}, defined as V_{O}/V_{EA}, strongly depends on converter input voltage V_{IN} and load current I_{O}. Due to the strong dependence of transfer function G_{VC} on the operating condition, it is not possible to design wide-bandwidth control loop which has adequate stability margins in all operating points. This limitation of the DFC loop bandwidth causes poor converter transient response to fast changes of the input voltage and the load current. Also, in switching AC-DC power supplies, where the resonant converter is used as the DC-DC stage, there is a considerable low-frequency input voltage ripple at the DC-DC stage input. The ripple frequency is doubled with respect to the AC line frequency and is approximately in the 100-120 Hz range (for typical ac sources). The low-frequency input ripple of the DC-DC stage propagates to the output where it can be the dominant part of the total output ripple whose magnitude is limited by the AC-DC power supply specifications. The attenuation of the low-frequency ripple strongly depends on the DFC loop gain magnitude in 100-120 Hz range which could be insufficient because of the narrow DFC bandwidth.

In the past, there have been two published major approaches to improve the resonant converter transient response and reduce the low-frequency output voltage ripple. The first approach is a combination of the direct frequency feedback control (DFC) and the input voltage feedforward control (VFC), as described in Ref. [4]. FIG. 4 shows one of the configurations of the combined control described in Ref. [4]. Input voltage V_{IN} is sensed and processed by feedforward controller whose output signal V_{FF} is summed with output signal V_{EA} of feedback controller. The resulting control signal V_{CONT} is applied to the VCO input. The feedforward control path provides much faster way to change control signal V_{CONT} in response to the disturbance of input voltage V_{IN} than the DFC path, where the input voltage disturbance first has to propagate through the power stage to the output, push output voltage V_{O} from its steady-state value, and, then, be further processed by the EA to produce EA output signal V_{EA}. FIG. 5 is a small-signal block diagram of a conventional LLC resonant converter with the direct frequency control and the input voltage feedforward control. To determine the ideal transfer function of the feedforward control, the small-signal block diagram of FIG. 5 for the combined control in FIG. 4 is employed. As shown in FIG. 5, the block diagram includes:
1. transfer function G_{VV} from input voltage V_{IN} to output voltage V_{O} with feedback and feedforward control paths opened;
2. transfer function G_{VC} from control voltage V_{CONT} to output voltage V_{O};
3. transfer function K_{D} of the output voltage sensor;
4. transfer function G_{EA} of error amplifier;
5. combined transfer function G_{FV}^{FC} of input voltage sensor and feedforward controller;
   Transfer function G_{VV}^{CL} from input voltage V_{IN} to output voltage V_{O} with the feedback and feedforward paths closed is derived from the block diagram in FIG. 5 as

$${G}_{VV}^{CL} = \frac{{V}_{O}}{{V}_{IN}} = \frac{{G}_{VV} + {G}_{FV}^{FC} \cdot {G}_{VC}}{1 + {T}_{V}} , \qquad ( 1 )$$

where T_{V}=K_{D}·G_{EA}·G_{VC} is the feedback loop gain.

Equation (1) indicates that complete cancellation of the small-signal input voltage disturbance is possible when

$${G}_{FV}^{FC} = - {G}_{VV} / {G}_{VC} . \qquad ( 2 )$$

It should be noted that ideal small-signal feedforward control transfer function G_{FV}^{FC}, defined by equation (2), cannot completely cancel the real-life input disturbance for two major reasons:
1. Both power stage and feedback frequency control are nonlinear blocks and their large-signal behavior cannot be adequately represented by small-signal transfer functions G_{VV} and G_{VC} which depend on converter operating point, namely, on the input voltage and the output current;
2. Since both transfer functions G_{VV} and G_{VC} are frequency dependent, the ideal transfer function G_{FV}^{FC} is also frequency dependent. The accurate implementation of its all poles and zeroes could be too complex for practical feedforward control.

FIG. 6 shows Bode plots of an ideal input voltage feedforward control transfer function G_{FV}^{FC}. The Bode plots of this idealized model are provided as an example in Ref. [4]. The transfer function G_{FV}^{FC} EC in FIG. 6 has flat gain and close-to-zero phase in the frequency range from zero to 10 KHz. Therefore, it is possible to approximate the ideal transfer function G_{FV}^{FC} by its dc gain, i.e., the proportional feedforward controller with its simple implementation can be used. This property of the ideal transfer function is determined by transfer functions G_{VV} and G_{VC} which depend on the power stage and the feedback control used.

As stated in Ref. [4], the objective of the combined feedback and line feedforward controls is the reduction of low-frequency output voltage ripple. This combined control solution is expected to be effective for improvement of the LLC resonant converter response to the other input voltage disturbances. However, it is obviously not capable of improving the converter response to load current disturbances.

FIG. 7 is a block diagram of a conventional zero-voltage-switching (ZVS) DC-DC converter with two-loop control. The two-loop control is disclosed in Ref. [5] to improve dynamic performance of the resonant ZVS converter. As shown in FIG. 7, a ZVS converter 1 is connected to one load circuit 2, 3. The ZVS converter 1 feeds the load circuit 2, 3 and comprises a chopper 4, a driver 5 connected to the chopper 4 for driving the chopper 4, and a resonant tank 6 connected to the chopper 4. A feedback circuit has no oscillator and comprises an arrangement 10 coupled to the resonant tank 6 for receiving a first signal derived from a resonant tank signal and coupled to the load circuit 2, 3 for receiving a second signal derived from a load circuit signal. The arrangement 10 generates, in response to the first and second signals, a control signal for the driver 5. Between the chopper 4 and the resonant tank 6, and/or between the resonant tank 6 and the load circuit 2, 3, further blocks, not shown, may be present, such as a transformer circuit, a rectifier circuit, a filter circuit, a measurement circuit, etc. The chopper 4 for example comprises a full bridge or a half bridge or a full bridge operated in a half bridge mode. A combination of the ZVS converter 1 and the feedback circuit for example forms a self-oscillating converter.

In one configuration, the feedback circuit is defined by the resonant tank signal being a voltage across or a current flowing through one or more elements of the resonant tank, and the load circuit signal being a voltage across or a current flowing through one or more elements of the load circuit. An element of the resonant tank may be a capacitor or a coil or a resistor. An element of the load circuit may be a load or a resistor.

Refs. [6]-[10] provide additional information relevant to the practical implementations of the resonant converter two-loop control.

FIG. 8 is a block diagram of a conventional DC-DC half-bridge LLC resonant converter with the average-current-mode control. Current-mode control is another major approach to improve the resonant converter transient response and reduce the low-frequency output voltage ripple. Refs. [11]-[12]. In addition to the DFC voltage feedback loop, there is a second feedback loop in FIG. 8. The second loop includes the sensor of resonant inductor current I_{LR}, whose output voltage V_{CS} is the input to the current processor. The current processor output voltage V_{CF} is then subtracted from output voltage V_{EA} of error amplifier EA. Different from PWM converters with a triangular inductor current waveform, resonant converters have resonant shape of inductor current I_{LR} waveform whose peak value does not coincide in time with turn-on/turn-off of primary switches S1 and S2. Therefore, peak-current-mode control is not used in resonant converters. However, the average-current-mode control is applicable to the resonant converters. In the case of average-current-mode control, current processor rectifies and averages the sensed inductor current I_{LR}. The current averaging introduces significant phase delay in the current loop which limits the current loop bandwidth. Therefore, improvement of the transient response of resonant converters with the described average-current-mode control is limited.

Another, more promising current-mode control implementation is a charge control. Ref. [13]-[22]. Different from DFC, the charge control does not have a VCO in the control path and, therefore, controls the switching frequency indirectly. There are two significantly-different implementations of the resonant converter charge control, called CC1 and CC2 in this disclosure. The CC1 implementation (Ref. [13]-[15]) is applied to the half-bridge LLC resonant converter.

FIG. 9 is a block diagram of a conventional DC-DC half-bridge LLC resonant converter with the CC1 implementation. The internal charge control loop produces the control signal VINT proportional to charge Q delivered by resonant inductor current I_{LR} during one half-switching cycle, namely, V_{INT}(t)∝Q(t)=∫ₜ_{ₒ}^{t}I_{LR}(t)dt, where to is the beginning time of the half-switching cycle. Signal V_{INT} in FIG. 9 is summed with compensation ramp signal V_{RAMP}. Similar to the peak-current-mode control, the compensation ramp is used to prevent the charge control subharmonic instability.

FIG. 10 shows key control waveforms of a conventional DC-DC half-bridge LLC resonant converter with the CC1 implementation. As shown in FIG. 10, the sum of signals V_{INT} and V_{RAMP} during the conduction time of upper switch S1 (t₀<t<t₁) is compared to error amplifier output voltage V_{EA}. When the increasing sum of signals V_{INT} and V_{RAMP} exceeds the V_{EA} level at time instant t₁, the output of comparator Cmp changes its state from low to high and switch S1 in FIG. 9 is turned off. The on-time of switch S1 is memorized. After dead-time interval t₁<t<t₂, lower switch S2 is turned-on for the same time, i.e., the times of intervals [t₀-t₁] and [t₂-t₃] are equal. At instant t₄, after dead-time interval t₃<t<t₄, the next switching cycle begins.

Signal V_{INT} is related to resonant inductor current I_{LR(AVE)}, averaged within half-switching cycle t₀<<t₂, which is defined by equation

$${I}_{LR ( AVE )} = \frac{2}{{T}_{S}} \cdot {\int }_{{t}_{0}}^{{t}_{2}} {I}_{LR} ( t ) dt ,$$

where T_{S} is the switching period. Neglecting short dead-time interval t₁<t<t₂, steady-state value of signal V_{INT}(t₁) is proportional to average inductor current I_{LR(AVE)} that shows close relationship between the charge control and the average current control.

Due to the inductor current sensing error and integrator inaccuracy, the deviation of practical V_{INT} signal from the ideal one can increase with time. For this reason, sometimes the reset signal is applied to the integrator every switching cycle to ensure the start of integrator output signal V_{INT} from zero at the beginning of each switching cycle, namely, at t=t₀, t₄, . . . .

In the resonant converters, where the resonant inductor L_{R} is connected in series with the resonant capacitor C_{R}, voltage VCR across the resonant capacitor is proportional to the integral of resonant inductor current I_{LR}, namely, V_{CR}=1/C_{R}·≡I_{LR}dt, sensing and integration of the resonant inductor current are replaced with sensing of the resonant capacitor voltage. Sensing of capacitor voltage V_{CR} is particularly beneficial in the LLC half-bridge resonant converter with the primary-side control, where resonant capacitor C_{R} is connected to the ground and the power stage and controller can share the same ground.

For the CC1 implementation, the same on-time of switches S1 and S2 is updated once per each switching cycle. For the CC2 implementation (Ref. [16]-[22]), the on-times of switches S1 and S2 are updated during S1 and S2 conduction intervals, respectively. The steady-state values of S1 and S2 on-times are the same during steady-state operation, but can be different during transients.

In Ref. [19], the CC2 implementation is called bang-bang charge control (BBCC). The BBCC for the half-bridge LLC converter, presented in Ref. [19], is represented by the block diagram in FIG. 11 and its key waveforms are shown in FIG. 12. This control is based on sensing of resonant capacitor voltage V_{CR} and input voltage V_{IN}. For proper operation of the control, the sensors of the voltages V_{CR} and V_{IN} must have identical gains. The BBCC operates as follows.

Upper switch S1 turns on at time instant to, as shown in FIG. 12. As a result, the resonant capacitor voltage starts increasing after the initial drop. At time instant t₁, sensed voltage K_{SEN}·V_{CR} exceeds EA output voltage V_{EA} and the output state of comparator Cmp2 changes from low to high, SR latch in FIG. 12 is reset and switch S1 turns off. After dead-time interval t₁<t<t₂, lower switch S2 turns on. During interval t₂<t<t₃, the resonant capacitor voltage starts decreasing after the initial peaking. At time instant t₃, when sensed voltage K_{SEN}·V_{CR} drops below level K_{SEN}·V_{IN}−V_{EA}, the output state of comparator Cmp1 changes from low to high, SR latch is set and switch S2 is turned off. After dead-time interval t₃<t<t₄, the next switching cycle begins.

For the charge control, the average value of the sensed current is obtained each switching cycle and, therefore, the charge control response to variation of the sensed current can be very fast and the charge loop bandwidth can be very high. Due to its high bandwidth, the charge control significantly improves the converter response to the input voltage disturbances and reduces the output 100-120-Hz voltage ripple. However, the charge control does not improve the converter response to the load current disturbances as significantly as it improves the response to the input voltage disturbances. This happens because the charge control belongs to the current-mode control family. Namely, the internal current loop substantially increases the converter output impedance with the voltage loop open. Typically, the open-loop output impedance of the converter with the charge control is much higher than that of the converter with direct frequency control. Although the high open-loop output impedance of the converter with the charge control is then drastically reduced by the action of the wide-bandwidth voltage loop, the closed-loop output impedance reduction of the converter with the charge control is not as significant as that of the converter with the DFC.

### REFERENCES

[1] J.-H. Jung, H.-S. Kim, M.-H. Ryu, and J.-W. Baek, “Design Methodology of Bidirectional CLLC Resonant Converter for High-Frequency Isolation of DC Distribution Systems,” IEEE Transactions on Power Electronics, vol. 28, no. 4, pp. 1741-386 Apr. 2013.
[2] W. Chen, P. Rong, and Z. Lu, “Snubberless Bidirectional DC-DC Converter With New CLLC Resonant Tank Featuring Minimized Switching Loss,” IEEE Transactions on Industrial Electronics, vol. 57, no. 9, pp. 3075-386 Sep. 2010.
[3] Z.-U. Zahid, Z.-M. Dalala, R. Chen, B. Chen, and J.-S. Lai, “Design of Bidirectional DC-DC Resonant Converter for Vehicle-to-Grid (V2G) Applications,” IEEE Transactions on Transportation Electrification, vol. 1, no. 3, pp. 232-244, October 2015.
[4] S. J. Deng, Q. F. Liu, G. Q. Li, Z. F. Zhou and Z. T Fan, “LLC Resonant Converter and Method for Suppressing Ripples in Output Voltage Thereof,” U.S. Patent Pre-Grant Publication No. 2016/0373015 A1, Dec. 22, 2016.
[5] R. Elferich, “Feedback circuit for zero-voltage-switching converter,” International Patent WO 2011/055285 A3, May 12, 2011.
[6] V. T. Ranganathan, P. D. Ziogas, and V. R. Stefanovic, “A Regulated DC-DC Voltage Source Converter Using a High Frequency Link,” IEEE Transactions on Industry Applications, vol. IA-18, no. 3, pp. 279-244, May-June 1982.
[7] F. C. Schwarz, “An Improved Method of Resonant Current Pulse Modulation for Power Converters,” IEEE Trans. Ind. Electron. Contr. Instrum., vol. IECI-23, no. 2, pp. 133-141, May 1976.
[8] R. Oruganti, J. J. Yang, and F. C. Lee, “Implementation of Optimal Trajectory Control of Series Resonant Converter,” IEEE Transactions on Power Electronics, vol. 3, no 3, pp. 318-327, July 1988.
[9] R. Oruganti and F. C. Lee, “Resonant Power Processors, Part II-Methods of Control,” IEEE Transactions on Industry Applications, vol IA-21, no 6, pp. 1461-1471 November-December 1985.
[10] R. King and T. Stuart, “Inherent overload protection for the series resonant converter,” IEEE Transactions on Aerospace Electronic Systems, vol. AES-19, no. 6, pp. 820-830, November 1983.
[11] C. H. Park, S. H. Cho, J. Jang, S. K. Pidaparthy, T. Ahn, and B. Choi, “Average Current Mode Control for LLC Series Resonant DC-to-DC Converters,” Journal of Power Electronics, vol. 14, no. 1, pp. 40-47, January 2014.
[12] J. Jang, S. K. Pidaparthy, and B. Choi, “Current Mode Control for LLC Series Resonant DC-to-DC Converters,” Energies, no. 8, pp. 6098-6113 Jun. 2015.
[13] H. Choi, “Charge Current Control for LLC Resonant Converter,” in IEEE 2015 Applied Power Electronics Conference, 2015, pp. 1448-1452.
[14] W.-T. Lee, H.-S. Baek, J. H. Jang, H.-S. Choi, M.-H. Choi, “Resonant Converter and Driving Method Thereof,” U.S. Pat. No. 9,729,072 B2, Aug. 8, 2017.
[15] C. Adragna, “Control Device for a Resonant Converter,” U.S. Pat. No. 8,737,092 B2, May 27, 2014.
[16] C. Cantoro, “Control Device for a Resonant Converter,” U.S. Pat. No. 9,019,725 B2, Apr. 28, 2015.
[17] J. Hu, Y. F. Liu, and P. C. Sen, “Cycle-by-Cycle Average Input Current Sensing Method for LLC Resonant Topologies,” in IEEE Energy Conversion Congress and Exposition, 2013, pp. 167-174.
[18] J. Hu, Y. F. Liu, and P. C. Sen, “Bang-Bang Charge Control for LLC Resonant Converters,” IEEE Transactions on Power Electronics, vol. 14, no. 1, pp. 40-47, January 2014.
[19] Y. Li, B. McDonald, “A Novel LLC Resonant Controller with Best-In-Class Transient Performance and Low Standby Power Consumption,” in IEEE Applied Power Electronics Conference, 2018, pp. 489-493, March 2018.
[20] R. Nielsen, S. K. Christensen, “Charge Mode Control of a Serial Resonance Converter,” U.S. Pat. No. 7,656,691 B2, Feb. 2, 2010.
[21] C. Adragna and A. Bianco, “Cycle-by-Cycle Average Input Current Control of Resonant Converters,”,2020 International Symposium on Power Electronics, Electrical Drives, Automation and Motion (SPEEDAM), Sorrento, Italy, pp. 839-845, June 2020.
[22] S.-W. Kang, and B.-H. Cho, “Digitally Implemented Charge Control for LLC Resonant Converters,” IEEE Transactions on Industrial Electronics, vol. 64, no. 8, pp. 6159-6168 Aug. 2017.

### SUMMARY OF THE INVENTION

The present disclosure provides a control method, in which the charge control is combined with input voltage feedforward control and/or output current feedforward control. It can be shown that the combination of the charge control with the feedforward control performs better than the combination of the DFC with the feedforward control. In particular, the combination of the charge control with the feedforward control has much better load transient response with respect to the load transient response of the combined direct frequency control and feedforward control.

The present disclosure also provides a cost-effective implementation of the charge control in the full-bridge LLC converter with controller located on the secondary side of the isolation transformer. The present disclosure can be implemented using either analog or digital control or both.

In one aspect, an isolated DC-DC converter includes a full-bridge switching stage having a plurality of active switches; a resonant network having a plurality of resonant components; a transformer connected to the resonant network; an output stage connected to the transformer and configured to generate an output signal, wherein the output signal is an output voltage or output current; an error amplifier generating an error signal based on the output signal and a reference signal, wherein the reference signal is a reference voltage or reference current; a feedforward controller sensing an input voltage of the full bridge switching stage and generating a feedforward control signal based on the sensed signal; a charge sensor connected to the resonant network or the full-bridge switching stage and configured to generate at least one charge sensing signal; and a switch controller generating and providing switch control signals to the plurality of active switches in charge control mode based on at least the error signal, the feedforward control signal and the charge sensing signal.

In one embodiment, an output of the feedforward controller and the error signal of the error amplifier are combined to generate a combined signal, and the feedforward control signal is generated based on the combined signal and the charge sensing signal.

In one embodiment, the feedforward control signal is generated based on the combined signal, and the switch control signals are generated based on the feedforward control signal and the charge sensing signal.

In one embodiment, the feedforward controller includes a voltage feedforward controller configured to sense the input voltage of the full bridge switching stage and produce a voltage feedforward output.

In one embodiment, the error signal is a voltage error signal, and the combined signal is generated by subtracting the voltage feedforward output from the error signal.

In one embodiment, the feedforward controller further includes a current feedforward controller configured to sense the output current of the output stage and produce a current feedforward output.

In one embodiment, the error signal is a current error signal, wherein the combined signal is generated by summing the current feedforward output with the error signal.

In one embodiment, the feedforward control signal is generated based on the combined signal and the voltage feedforward output.

In one embodiment, the at least one charge sensing signal corresponds to at least one of the following: one of the plurality of resonant components, the plurality of active switches, the full-bridge switching stage.

In one embodiment, the plurality of resonant components include at least a resonant inductor and a resonant capacitor, and the charge sensing signal corresponds to the resonant inductor or the resonant capacitor.

In one embodiment, the charge sensing signal corresponds to an inductor current flowing through the resonant inductor or a capacitor voltage across the resonant capacitor.

In one embodiment, the charge sensor is implemented as a voltage transformer, a current transformer or sensing winding of a resonant magnetic component.

In one embodiment, the charge sensor is implemented as the sensing winding of the resonant magnetic component and is configured to generate the charge sensing signal corresponding to a voltage across the sensing winding.

In one embodiment, the charge sensor is implemented as the current transformer and is configured to generate the charge sensing signal corresponding to a current of the resonant inductor.

In one embodiment, the charge sensor is implemented as the voltage transformer and is configured to generate the charge sensing signal corresponding to a voltage across one of the resonant capacitors.

In one embodiment, the charge sensor is configured to generate a plurality of said charge sensing signals corresponding to currents flowing through branches of the full-bridge switching stage.

### BRIEF DESCRIPTION OF THE DRAWINGS

FIG. 1 is a block diagram of a resonant isolated DC-DC converter.

FIG. 2 is a circuit diagram of a conventional LLC resonant DC-DC converter. The converter in FIG. 2 has a full-bridge switching stage on the primary side, a full-bridge rectifier on the secondary side, and a CLC output filter.

FIG. 3 is a block diagram of a full-bridge LLC resonant DC-DC converter with direct frequency control.

FIG. 4 is a block diagram of a half-bridge LLC resonant DC-DC converter with direct frequency control and input voltage feedforward control.

FIG. 5 is a small-signal block diagram of an LLC resonant converter with direct frequency control and input voltage feedforward control.

FIG. 6 shows Bode plots of control-to-output transfer function G_{VC}, open-loop audio-susceptibility transfer function G_{VV}, and ideal transfer function G_{FV}^{FC} of the input voltage feedforward control for the LLC converter with direct frequency control.

FIG. 7 is a block diagram of a resonant zero-voltage-switching DC-DC converter with two-loop control.

FIG. 8 is a block diagram of a conventional half-bridge LLC resonant DC-DC converter with the average-current-mode control.

FIG. 9 is a block diagram of a conventional half-bridge LLC resonant DC-DC converter with the CC1 implementation.

FIG. 10 shows key control waveforms of a conventional half-bridge LLC resonant DC-DC converter with the CC1 implementation.

FIG. 11 is a block diagram of a conventional half-bridge LLC resonant DC-DC converter with the CC2 implementation.

FIG. 12 shows key control waveforms of a conventional half-bridge LLC resonant DC-DC converter with the CC2 implementation.

FIG. 13A shows a combined block diagram of a full-bridge LLC resonant converter with the output voltage regulated and the charge control based on sensing voltages or currents of the resonant network in accordance with an embodiment of the present disclosure.

FIG. 13B shows a combined block diagram of a full-bridge LLC resonant converter with the output voltage regulated and the charge control based on sensing currents of the switching stage in accordance with an embodiment of the present disclosure.

FIG. 13C shows a combined block diagram of a full-bridge LLC resonant converter with the output current regulated and the charge control based on sensing voltages or currents of the resonant network in accordance with an embodiment of the present disclosure.

FIG. 14 shows a circuit diagram of a charge sensor based on the sensing winding of resonant inductor in accordance with an embodiment of the present disclosure.

FIG. 15 shows a circuit diagram of a charge sensor based on sensing resonant inductor current I_{LR}, in accordance with an embodiment of the present disclosure.

FIG. 16 shows a circuit diagram of a charge sensor based on sensing resonant capacitor voltage V_{CR} with a voltage transformer in accordance with an embodiment of the present disclosure.

FIG. 17A shows a block diagram of the charge control based on sensing voltages or currents of the resonant network and combined with the output current feedforward control and the input voltage feedforward control in accordance with an embodiment of the present disclosure.

FIG. 17B shows a block diagram of the charge control based on sensing currents of the switching stage and combined with the output current feedforward control and the input voltage feedforward control in accordance with an embodiment of the present disclosure.

FIG. 17C shows a block diagram of the charge control based on sensing voltages or currents of the resonant network and combined—the input voltage feedforward control in accordance with an embodiment of the present disclosure.

FIG. 18 shows a small-signal block diagram of the resonant converter with the charge control combined with the output current feedforward control in accordance with an embodiment of the present disclosure.

FIG. 19 shows exemplary Bode plots of transfer functions Z_{TH}, G_{VC}^{CC}, and G_{FI} of a full-bridge LLC converter with the charge control and the output current feedforward control in accordance with an embodiment of the present disclosure.

FIG. 20 shows a block diagram of the direct frequency control combined with the output current feedforward control in accordance with an embodiment of the present disclosure.

FIG. 21 shows a small-signal block diagram of a resonant converter with the direct frequency control combined with the output current feedforward control in accordance with an embodiment of the present disclosure.

FIG. 22 shows exemplary Bode plots of transfer functions Z_{O}^{OL}, G_{VC}, and G_{FI}^{FC} of a full-bridge LLC converter with the direct frequency control and the output current feedforward control in accordance with an embodiment of the present disclosure.

FIG. 23 shows Bode plots of OCF control transfer functions G_{FI} and G_{FI}^{FC} for the charge control and the direct frequency control, respectively, in accordance with an embodiment of the present disclosure.

FIG. 24 shows the output voltage response to the output current pulse for the LLC converter with the charge control and for the LLC converter with the DFC, with and without the OCF control, in accordance with an embodiment of the present disclosure.

FIG. 25 shows a block diagram of the charge control combined with the input voltage feedforward control in accordance with an embodiment of the present disclosure.

FIG. 26 shows a small-signal block diagram of a resonant converter with the charge control combined with the input voltage feedforward control in accordance with an embodiment of the present disclosure.

FIG. 27 shows exemplary Bode plots of transfer functions G_{VV}^{CC}, G_{VC}^{CC}, and G_{FV}^{FC} of a full-bridge LLC converter with the charge control and the input voltage feedforward control.

FIG. 28 shows magnitude plots of the closed-loop audio-susceptibility G_{VV}^{CL} for the LLC converter charge control, with and without the input voltage feedforward control, in accordance with an embodiment of the present disclosure.

FIG. 29 shows the output voltage response to the input voltage 100-Hz ripple for an LLC converter with the charge control, with and without the IVF control in accordance with an embodiment of the present disclosure.

FIG. 30 shows exemplary Bode plots of transfer functions G_{VV}, G_{VC}, and G_{FV}^{FC} of a full-bridge LLC converter with the DFC and the input voltage feedforward control in accordance with an embodiment of the present disclosure.

FIG. 31 shows magnitude plots of closed-loop audio-susceptibility G_{VV}^{CL} for DFC, with and without the input voltage feedforward control in accordance with an embodiment of the present disclosure.

FIG. 32 shows the output voltage response to the input voltage 100-Hz ripple for an LLC converter with the DFC, with and without the IVF control in accordance with an embodiment of the present disclosure.

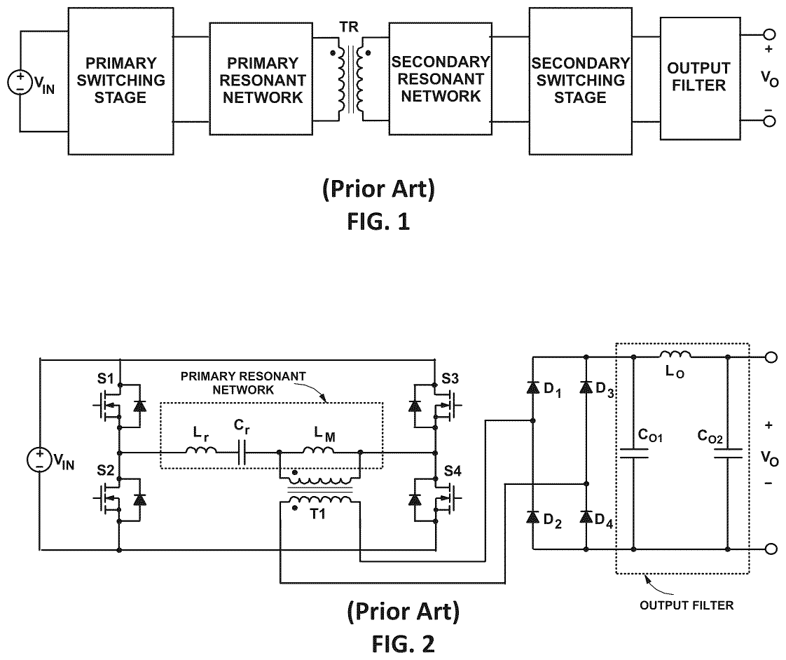

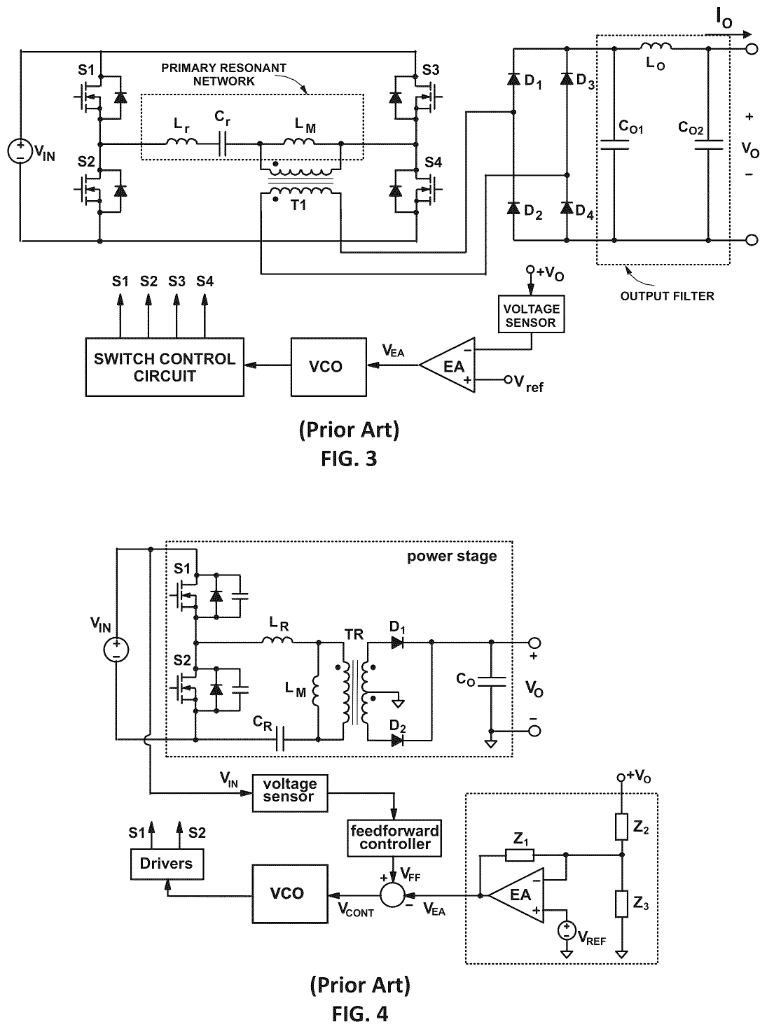

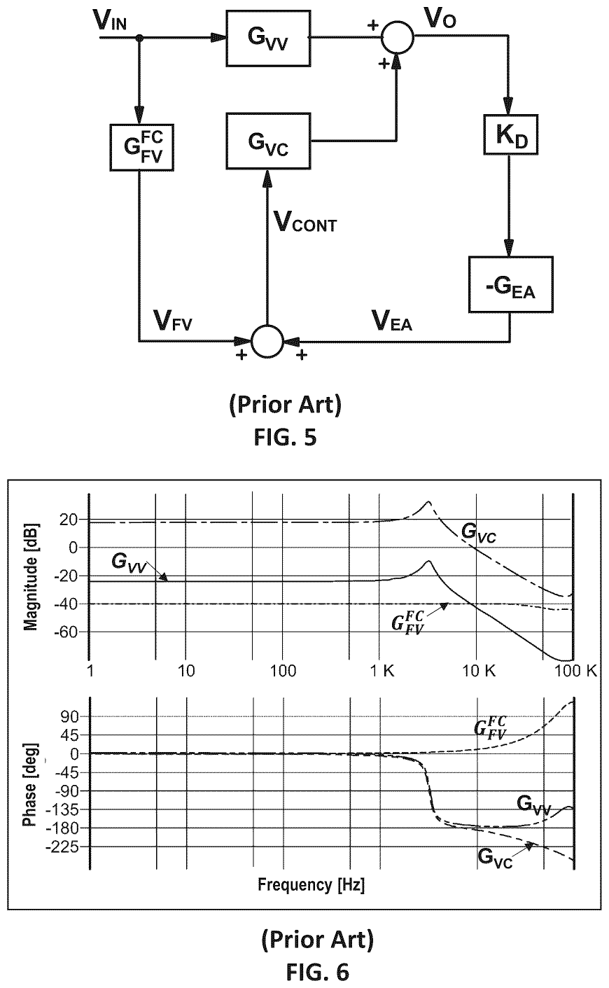

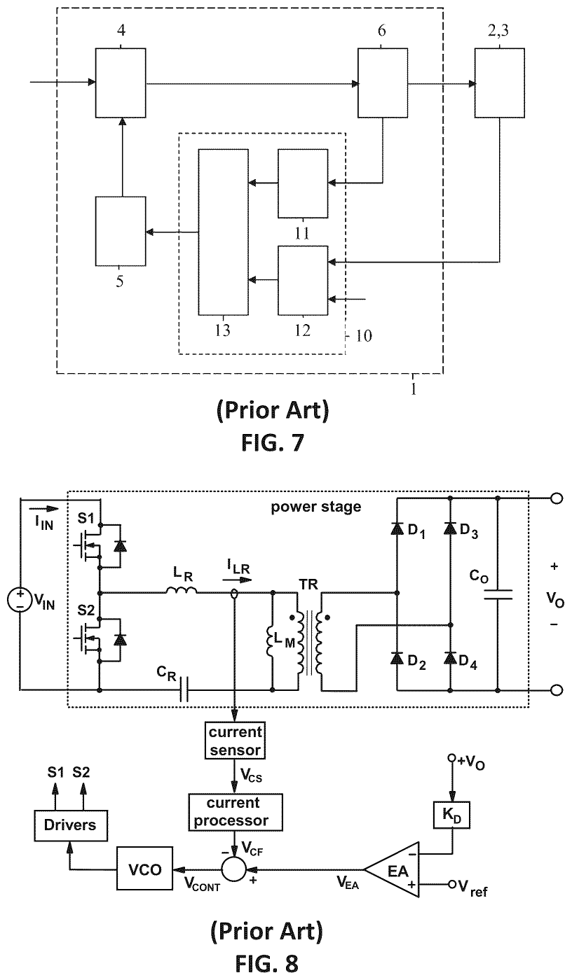

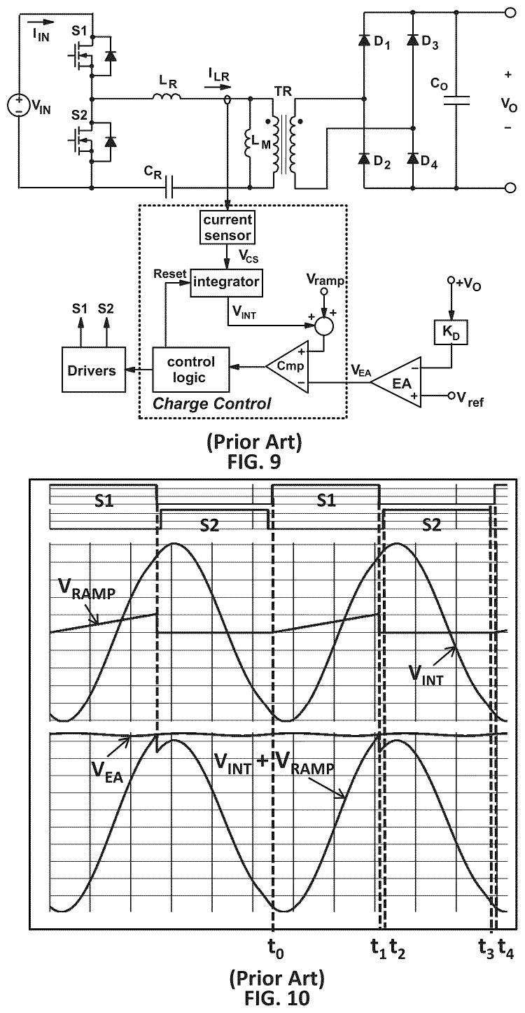

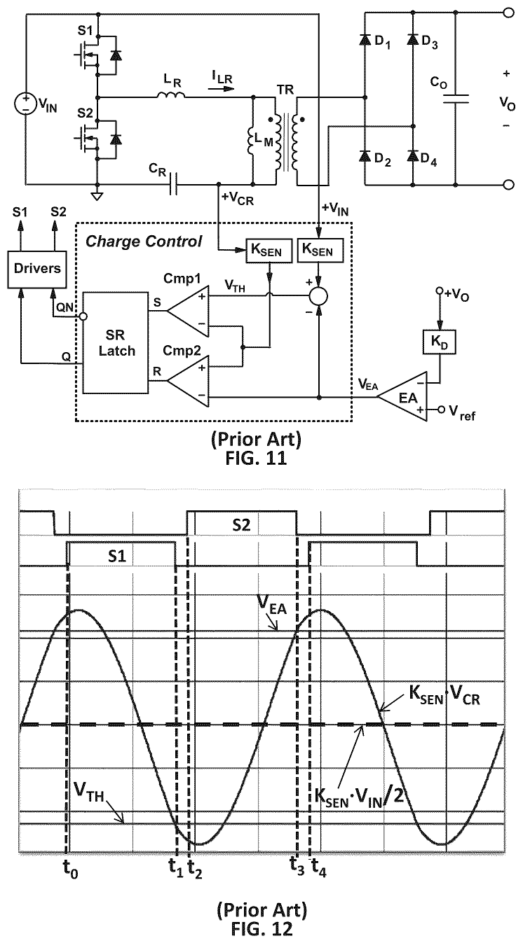

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

In this disclosure, a new control method to improve transient response to both load (I_{O}) and input (V_{IN}) disturbances and to reduce a low-frequency output voltage ripple of a resonant converter is provided. Previous publications mostly considered the application of charge control to half-bridge LLC. The inventors recognized and appreciated the need for a high-performance and cost-effective implementation of charge control in full-bridge LLC converters.

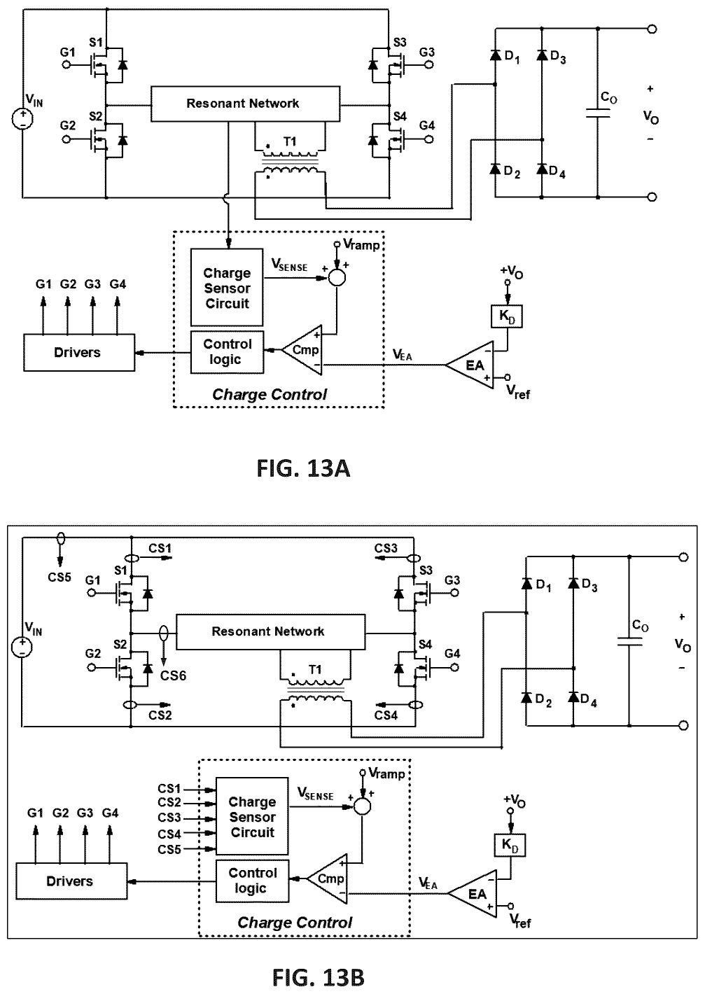

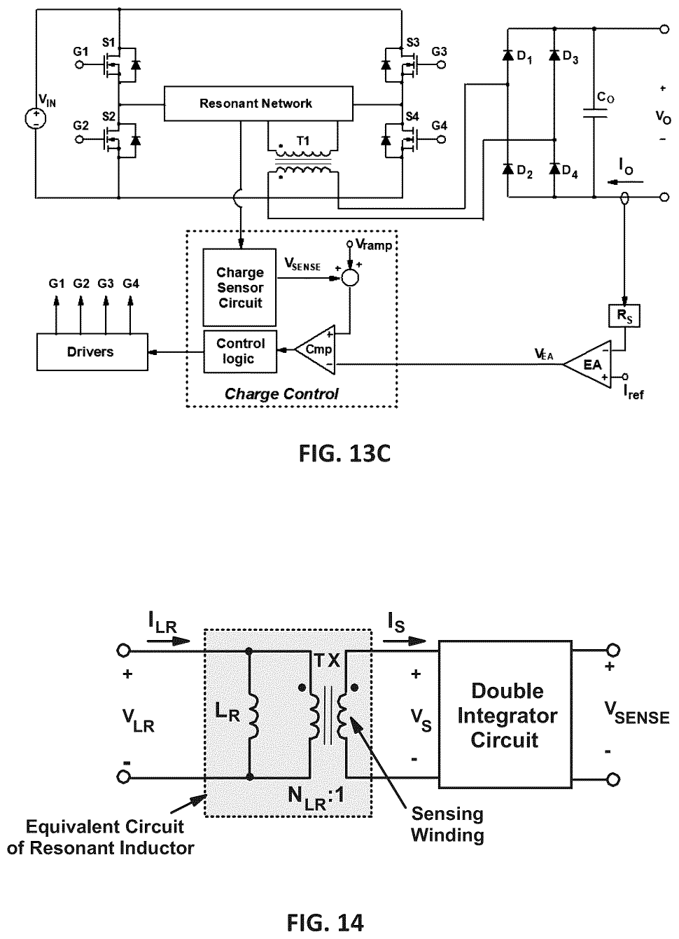

One aspect of the present disclosure is the implementations of charge control for regulating output voltage or current of a full-bridge LLC converter as shown in FIGS. 13A-13C. It can be observed that in the implementation of FIG. 13A, the input of the charge sensor circuit is the voltage or current of the resonant network while the inputs of the charge sensor circuit of FIG. 13B are the currents flowing through the switching stage. Note that the switching stage currents represent the resonant inductor current during the portions of the switching period or the entire period. In both implementations of FIGS. 13A and 13B, the error amplifier receives the sensed output voltage V_{O}. However, in the implementation of FIG. 13C, the error amplifier receives the sensed output current I_{O}. When implementation of the charge control in the full-bridge LLC converter is selected, there are several important practical considerations:
1. The full-bridge LLC topology is typically used for DC-DC converters whose output power is in the multi-kW range.
2. These high-power DC-DC converters typically employ digital control and are required to have multiple communication channels with the centralized power system controller. This communication is much simpler and cost-effective when the digital signal processor (DSP) is located on the transformer secondary side. In this case, communication signals have the same ground as the system controller and no isolation devices for communication channels are necessary.
3. With the DSP located on the secondary side, there is no need to transfer output voltage or current feedback signals over the isolation boundary. Today's analog signal isolation devices have either poor speed at low cost or adequate speed, but at high cost.

Taking these practical considerations into account, it is highly desirable to use an isolated charge sensor which can deliver the sensed signal directly to the secondary-side controller. There are several approaches which could potentially meet this requirement at low cost. In one embodiment (the first approach) the signal is sensed at the terminals of an additional sensing winding of the resonant inductor. In another embodiment (the second approach) the resonant inductor current is sensed with a current transformer. In yet another embodiment (the third approach) the resonant capacitor voltage is sensed with a voltage transformer. These three approaches are described below in detail.

An implementation of the first approach is shown in FIG. 14. The simplified equivalent circuit of the resonant inductor with sensing winding is shown inside rectangle 1410 in FIG. 14 and includes inductance L_{R} and ideal transformer TX with turns ratio N_{LR}:1, where N_{LR} is the number of power winding turns. The resonant inductor power winding is located on the left side of the drawing, whereas the sensing winding is located on the right side of the drawing. The sensing winding typically has one turn, but generally can have any number of turns.

Since voltage V_{LR} across the resonant inductor power winding is related to current I_{LR} as V_{LR}=L_{R} dI_{LR}/dt, voltage Vs across the sensing winding is proportional to the second derivative of charge Q. To obtain sensor output voltage V_{SENSE}, proportional to charge Q, a double integrator circuit 1420, shown in FIG. 14, is used.

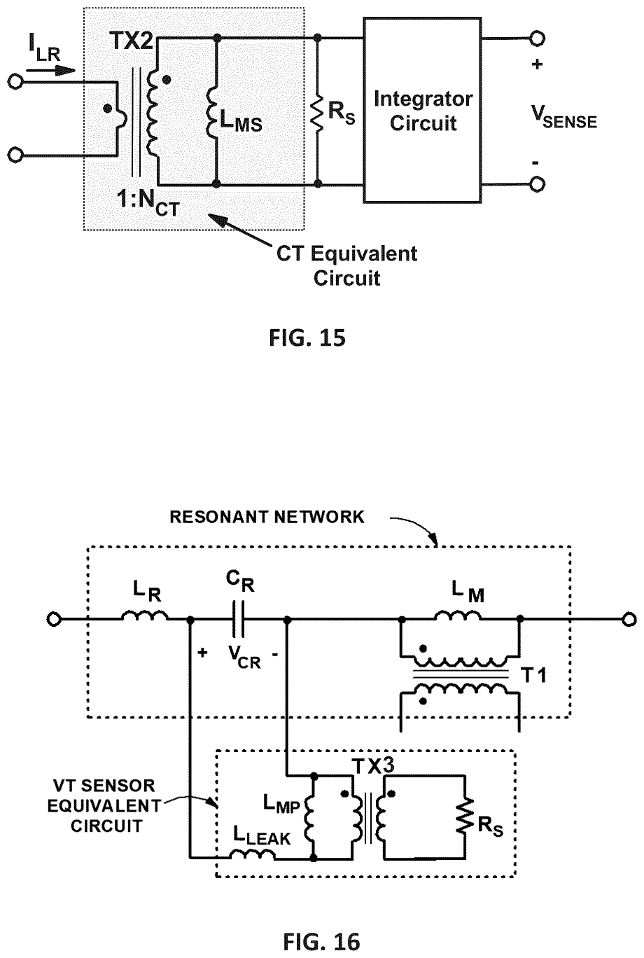

The second implementation of the isolated charge sensor is based on sensing of the resonant inductor current I_{LR} with the current transformer (CT). As shown in FIG. 15, CT is placed inside the resonant network in series with resonant inductor L_{R} (location CS6 on FIG. 13B) or around the primary switching network in any branches whose currents represent current I_{LR} during the switching period or the part of it. The examples of the CT placement around the switching network are shown in FIG. 13B as CS1-CS5. CT equivalent circuit in FIG. 15 includes ideal transformer TX2 with turns ratio 1:N_{CT} and secondary-side magnetizing inductance L_{MS}. The CT secondary winding loaded with resistor R_{S} provides the input signal for the integrator circuit in FIG. 15.

The third approach for the charge control of the full-bridge LLC converter is based on sensing of the resonant capacitor voltage with the voltage transformer (VT). The simplified equivalent circuit of the voltage transformer sensor is shown in FIG. 16, where TX3 is an ideal transformer with turns ratio N_{VT}, L_{MP} and L_{LEAK} are the primary-side magnetizing and leakage inductances, and R_{S} is the output resistor of the sensor.

With the disclosed sensing approaches, both CC1 and CC2 implementations in the full-bridge LLC converter are possible. For CC2 implementation in the full-bridge converter, sensing of the input voltage is not required.

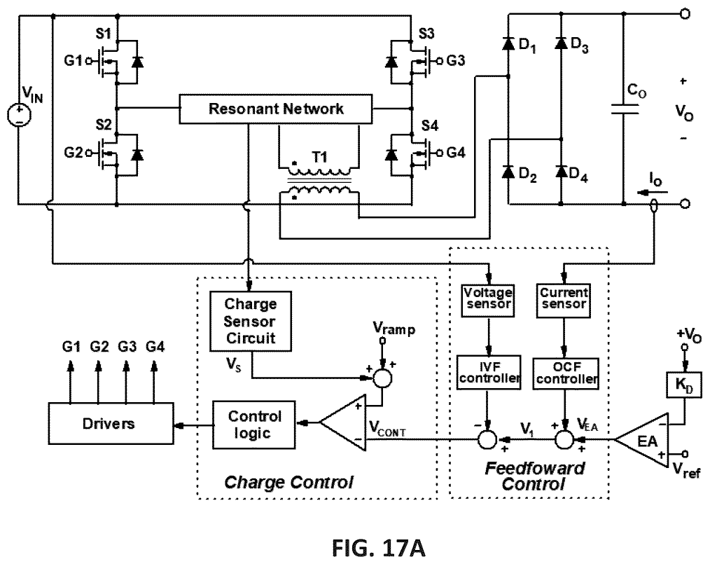

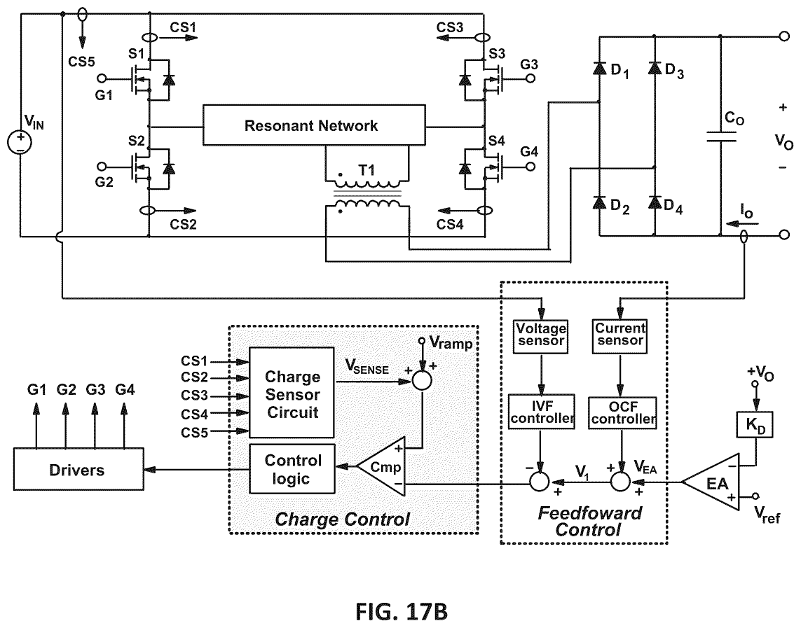

Another aspect of the present disclosure is the improvement of the LLC converter response to disturbances of the output current and input voltage. The improvement is achieved by combining the charge control with the feedforward output current control and the feedforward input voltage control. The corresponding control block diagram is shown in FIG. 17A. To implement output current feedforward (OCF) control, output current I_{O} in FIG. 17A is sensed and processed by OCF controller, whose output signal is summed with error amplifier output signal V_{EA}. To implement input voltage feedforward (IVF) control, input voltage V_{IN} is sensed and processed by IVF controller, whose output signal is subtracted from signal V1, as shown in FIG. 17A.

Other implementations of the OCF and IVF control are shown in FIGS. 17B and 17C. In the implementation of FIG. 17B, the charge sensor circuit receives the sensed current of one or several active switches and/or the input stage, rather than the resonant network. On the other hand, the error amplifier of FIG. 17C receives sensed output current I_{O}.

Note that the proposed feedforward control can have only input voltage feedforward control or only output current feedforward control or both of them. Usually, the charge control has much better input disturbance rejection than the direct frequency control (Refs. [19]-[20]), and, depending on converter specifications, the input voltage feedforward control may not be required. However, as was mentioned before, the charge control cannot significantly improve the load disturbance rejection with respect to DFC, and the output current feedforward control is highly desirable.

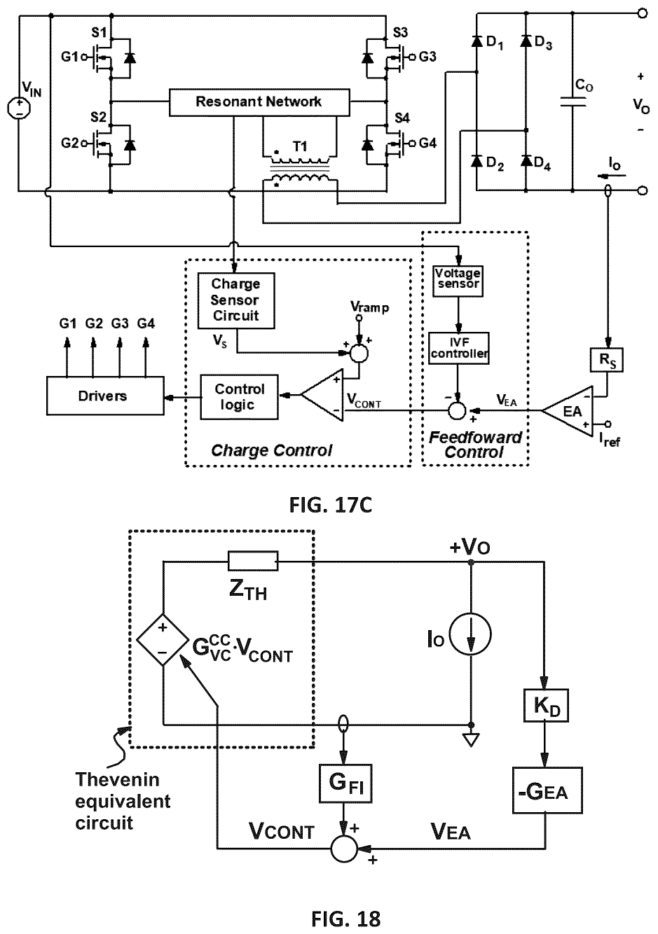

To determine ideal transfer function of the output current feedforward control, the small-signal block diagram of the disclosed control, shown in FIG. 18, is employed. For the converter with the charge control, its output port is represented in FIG. 18 with the Thevenin equivalent circuit, which includes Thevenin dependent voltage source G_{VC}^{CC}·V_{CONT} and Thevenin impedance Z_{TH}, where G_{VC}^{CC}=V_{O}/V_{CONT} is the control-to-output transfer function of the charge control and Z_{TH} is the converter output impedance with charge control loop closed, voltage feedback loop opened, and output current feedforward control loop opened.

In addition to the Thevenin equivalent circuit, the block diagram in FIG. 18 also includes:
1. Transfer function K_{D} of the output voltage sensor;
2. Transfer function G_{EA} of the error amplifier;
3. Combined transfer function G_{FI} of output current sensor and OCF controller.

When output voltage feedback path and output current feedforward path are closed, converter small-signal closed-loop output impedance Z_{O}^{CL} is derived from the block diagram in FIG. 18 as

$${Z}_{O}^{CL} = - \frac{{V}_{O}}{{I}_{O}} = \frac{{Z}_{TH} - {G}_{FI} \cdot {G}_{VC}^{CC}}{1 + {T}_{V}} , \qquad ( 3 )$$

where T_{V}=K_{D}·G_{EA}·G_{VC} is the voltage feedback loop gain.

Equation (3) indicates that complete cancellation of the small-signal output current disturbance is possible when

$${G}_{FI} = {Z}_{TH} / {G}_{VC}^{CC} . \qquad ( 4 )$$

It should be noted that ideal small-signal feedforward control transfer function G_{FI}, defined by equation (4), cannot completely cancel the real-life input disturbance for two major reasons:
1. Both power stage and feedback frequency control are nonlinear blocks and their large-signal behavior cannot be adequately represented by small-signal transfer functions Z_{TH} and G_{VC}^{CC} which depend on converter operating point, namely, on the input voltage and the output current;
2. Since both Z_{TH} and G_{VC}^{CC} are frequency-dependent transfer functions, ideal transfer function G_{FI} is also frequency dependent. The accurate implementation of its all poles and zeroes could be too complex for practical feedforward control.

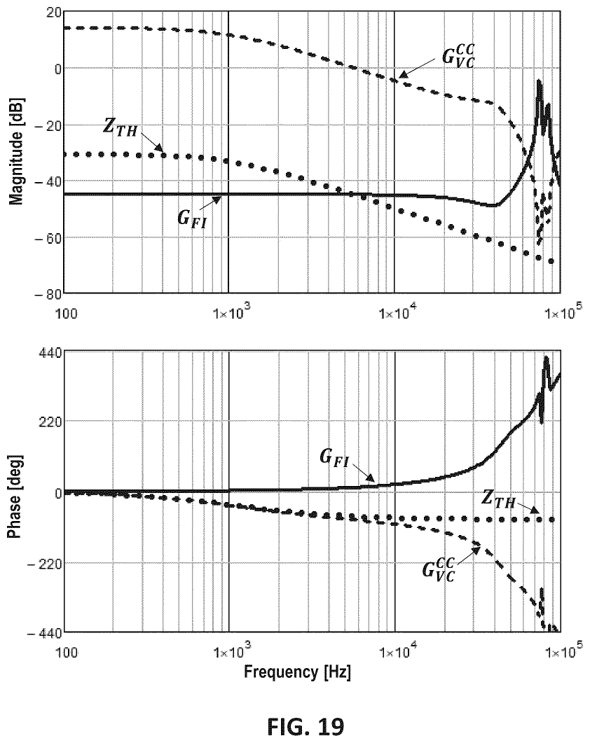

As an example, the Bode plots of transfer functions Z_{TH}, G_{VC}^{CC}, and G_{FI} of the full-bridge LLC converter with the charge control are shown in FIG. 19.

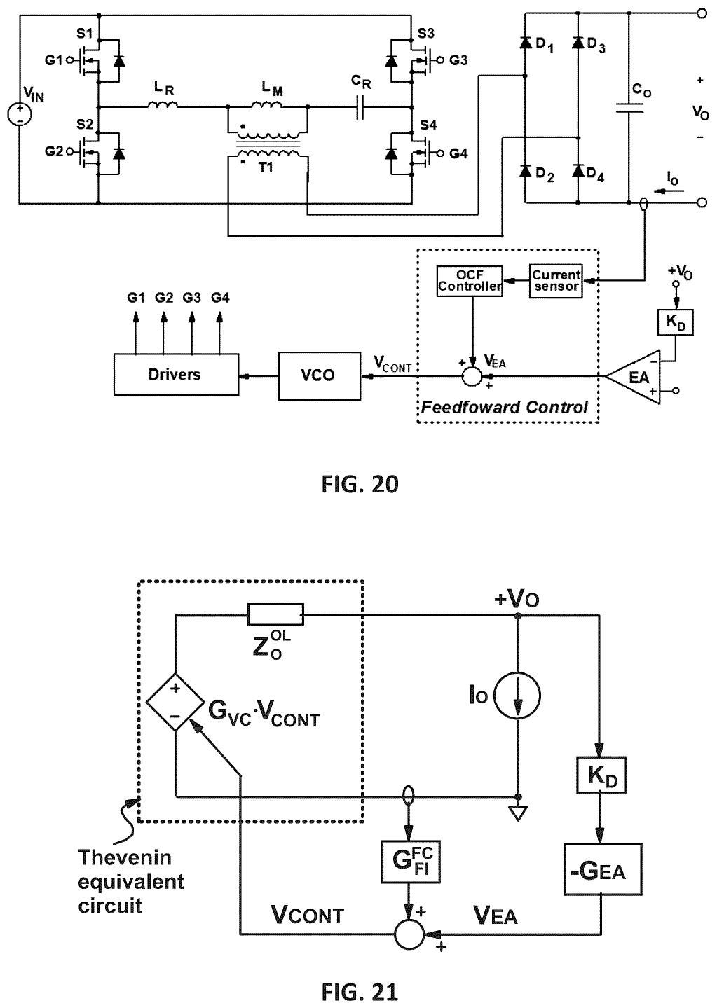

The output current feedforward control can be applied also to resonant converters with the direct frequency control. The exemplary implementation of the OCF control in the full-bridge LLC converter with the DFC is shown in FIG. 20, whereas its corresponding control block diagram is shown in FIG. 21. As for the charge control, the converter output port is represented in FIG. 21 with the Thevenin equivalent circuit, which includes Thevenin dependent voltage source G_{VC}·V_{CONT} and Thevenin impedance Z_{O}^{OL}, where G_{VC} is the DFC control-to-output transfer function and Z_{O}^{OL} is the converter output impedance with voltage feedback path opened and output current feedforward control path opened.

In addition to the Thevenin equivalent circuit, the block diagram in FIG. 21 also includes:
1. current source I_{O} which represents the small-signal load current perturbation;
2. transfer function K_{D} of the output voltage sensor;
3. Combined transfer function G_{FV}^{FC} of the output current sensor and OCF controller.

When output voltage feedback path and output current feedforward path are closed, converter closed-loop output impedance Z_{O}^{CL} is derived from the block diagram in FIG. 21 as

$${Z}_{O}^{CL} = - \frac{{V}_{O}}{{I}_{O}} = \frac{{Z}_{O}^{OL} - {G}_{FI}^{FC} \cdot {G}_{VC} \cdot }{1 + {T}_{V}} . \qquad ( 5 )$$

Equation (5) indicates that complete cancellation of the small-signal output current disturbance is possible when

$${G}_{FI}^{FC} = {Z}_{O}^{OL} / {G}_{VC} . \qquad ( 6 )$$

For the DFC, ideal small-signal feedforward control transfer function G_{FI}^{FC}, defined by equation (6), cannot completely cancel the real-life load disturbance for the same reasons mentioned above for transfer function G_{FI}, corresponding to the charge control.

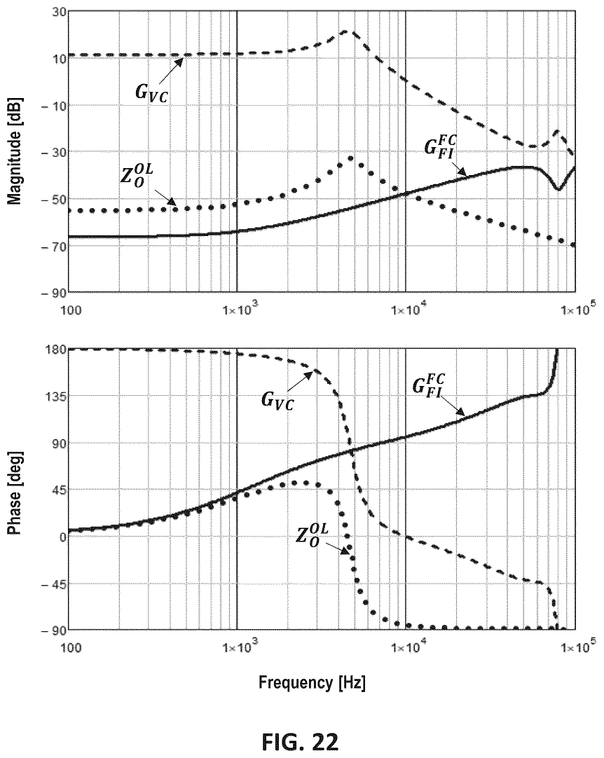

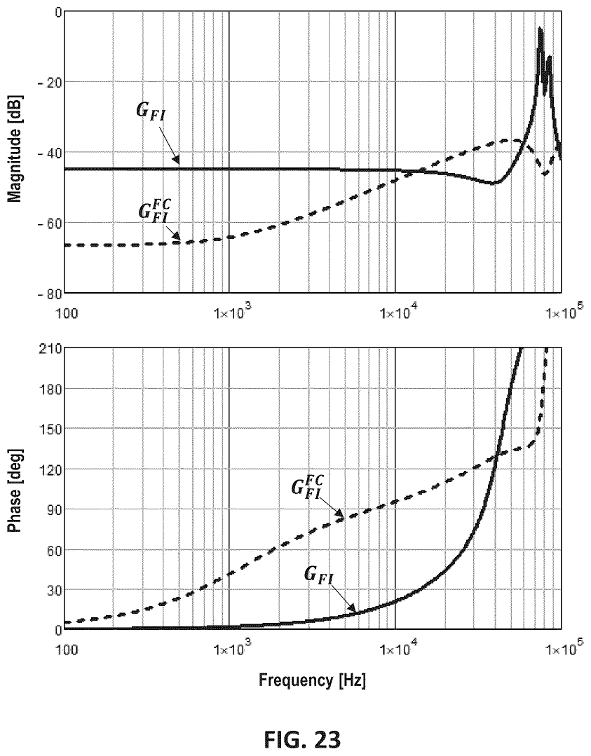

As an example, the Bode plots of transfer functions Z_{O}^{OL}, G_{VC}, and G_{FI}^{FC} of the full-bridge LLC converter with the DFC are shown in FIG. 22. For comparison, OCF control transfer functions G_{FI} and G_{FI}^{FC} for the charge control and the direct frequency control, respectively, are plotted in FIG. 23. For practical OCF control implementation, approximation of its control function by the constant gain is highly desirable. FIG. 23 reveals that transfer function G_{FI} can be approximated by the constant gain to much higher frequency than transfer function G_{FI}^{FC}. For example, the magnitude of transfer function G_{FI} deviates by 3 dB from its de value at 30.2-kHz frequency, whereas the magnitude of transfer function G_{FI}^{FC} deviates by 3 dB from its dc value at 1.2-kHz frequency. Also, the phase of transfer function G_{FI} deviates by 45° from zero value at 20.4-kHz frequency, whereas the phase of transfer function G_{FI}^{FC} deviates by 45° from zero value at 1.1-kHz frequency.

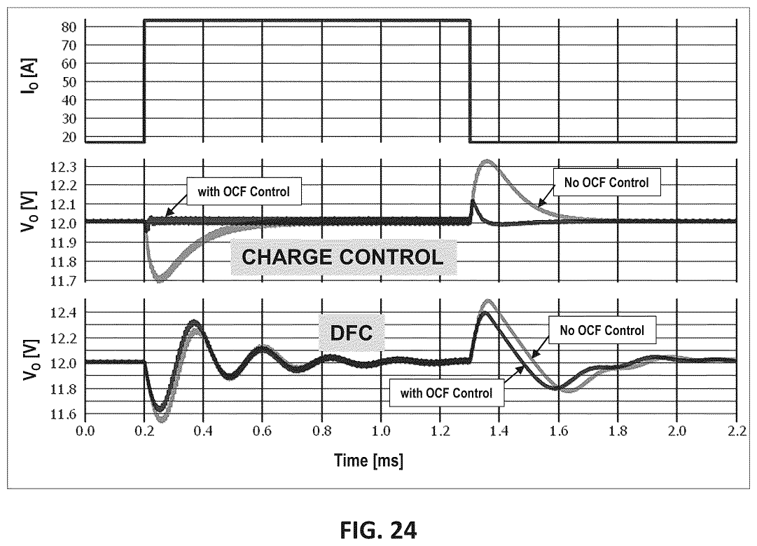

This is very significant advantage of the combined charge control and OCF control with respect to the combined DFC and OCF control. This advantage is demonstrated in FIG. 24, which shows the LLC converter response to the load disturbance. The upper plot in FIG. 24 shows the output current which steps up from 17 A to 83 A at time t=0.2 ms and steps back to 17 A at t=1.3 ms. The middle plot in FIG. 24 shows the transient waveforms of output voltage V_{O} for the charge control with and without the OCF control. This plot demonstrates that, with the OCF control added to the charge control, transient output voltage undershoot is reduced by 81% from −323 mV to −60 mV, whereas transient output voltage overshoot is reduced by 65% from 321 mV to 113 mV. The lower plot in FIG. 24 shows the transient waveforms of output voltage V_{O} for the DFC with and without the OCF control. This plot demonstrates that, with the OCF control added to the DFC, transient output voltage undershoot is reduced by 18% from −477 mV to −391 mV, whereas transient output voltage overshoot is reduced by 20% from 483 mV to 387 mV. The waveforms in FIG. 24 confirm that combination of the charge control with the OCF control is much more beneficial than combination of the DFC with the OCF control.

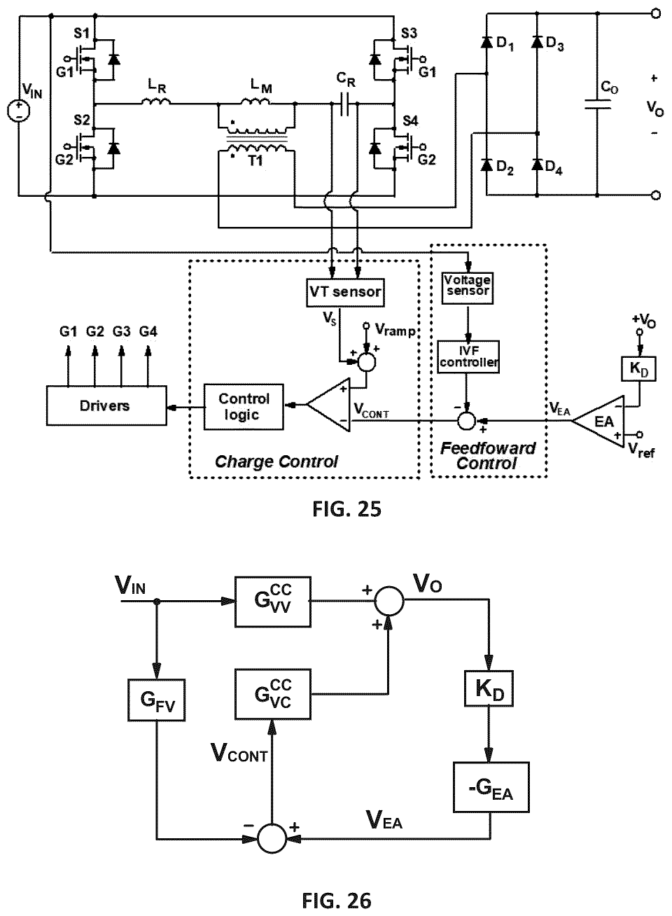

The disclosed implementation of the charge control with the input voltage feedforward (IVF) control is presented next. The block diagram of the disclosed control is shown in FIG. 25. To determine the ideal transfer function of the IVF control, the small-signal block diagram of the proposed control, shown in FIG. 26, is employed. The block diagram in FIG. 26 includes:
1. transfer function G_{VV}^{CC} from input voltage V_{IN} to output voltage V_{O} with the charge control loop closed and with the voltage feedback and feedforward control paths opened;
2. control-to-output transfer function G_{VV}^{CC} of the charge control;
3. transfer function K_{D} of output voltage sensor;
4. transfer function G_{EA} of error amplifier;
5. Combined transfer function G_{FV} of the input voltage sensor and feedforward controller.

Transfer function G_{VV}^{CL} from input voltage V_{IN} to output voltage V_{O} with the feedback and feedforward paths closed is derived from the block diagram in FIG. 26 as

$${G}_{VV}^{CL} = \frac{{V}_{O}}{{V}_{IN}} = \frac{{G}_{VV}^{CC} - {G}_{VC}^{CC} \cdot {G}_{FV}}{1 + {T}_{V}} , \qquad ( 7 )$$

where T_{V}=K_{D}·G_{EA}·G_{VC} is the voltage feedback loop gain.

Equation (7) indicates that complete cancellation of the small-signal input voltage disturbance is possible when

$${G}_{FV} = {G}_{VV}^{CC} / {G}_{VC}^{CC} . \qquad ( 8 )$$

It should be noted that ideal small-signal IVF control transfer function G_{FV}, defined by equation (8), cannot completely cancel the input disturbance for the reasons, explained earlier.

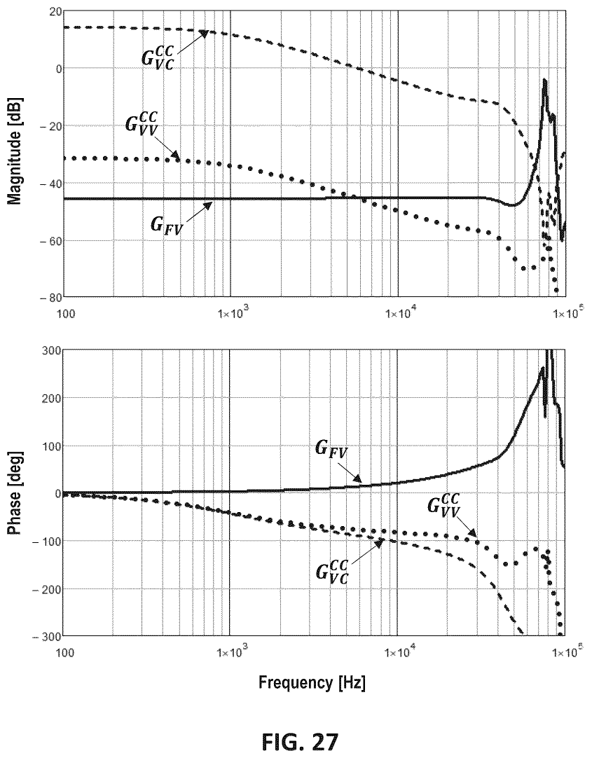

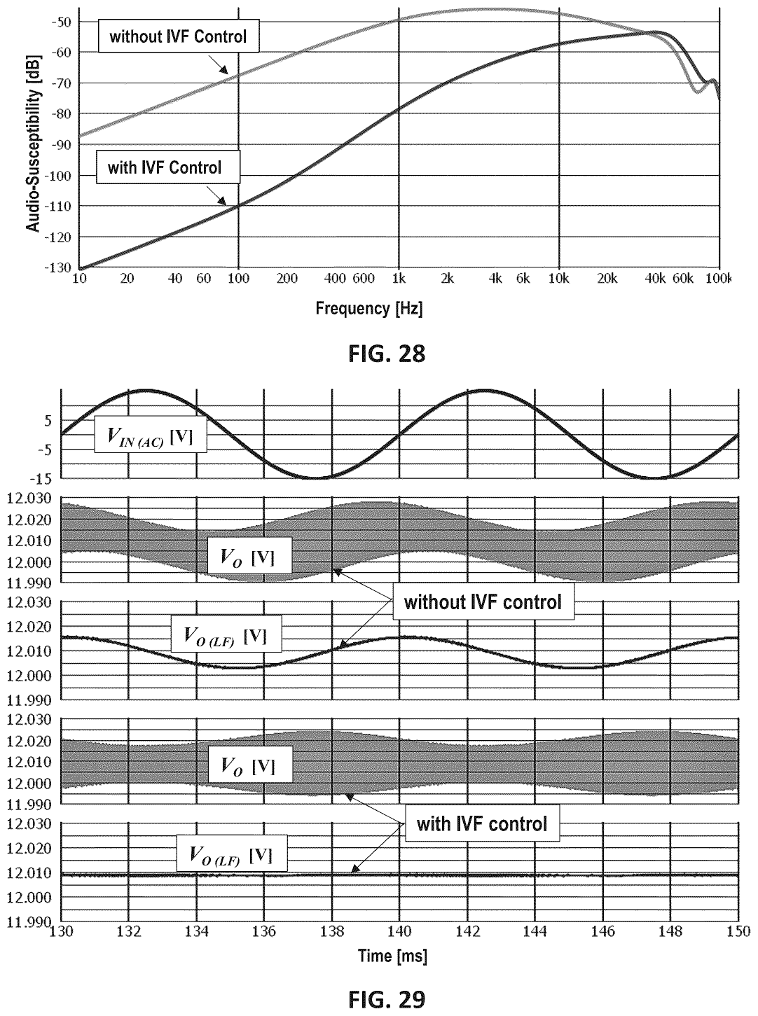

As an example, the Bode plots of transfer functions G_{VV}^{CC}, G_{VC}^{CC}, and G_{FV} of the full-bridge LLC converter with the charge control are shown in FIG. 27. At low frequencies, transfer function G_{FV} can be approximated with its dc gain. For example, the G_{FV} magnitude deviates from its dc value by 3 dB at 58.9-kHz frequency, whereas the G_{FV} phase deviates from zero by 45° at 23.4-KHz frequency. For the charge control and transfer function G_{FV} approximated by its dc gain, the Bode plots of input-to-output transfer function G_{VV}^{CL}, called closed-loop audio-susceptibility, of the full-bridge LLC converter with and without the IVF control were calculated from (11) and are shown in FIG. 28. In the off-line power supplies, the DC-DC stage is supplied from the front-end stage output which has considerable ripple of the doubled line frequency. The doubled line frequency is typically in the 100-120 Hz range. As the DC-DC stage output voltage has stringent ripple requirements, the low audio-susceptibility at the doubled line frequency is highly important. In FIG. 28, addition of the IVF control to the charge control reduces the audio-susceptibility by 42 dB from −68 dB to −110 dB at 100-Hz frequency.

Simulated input and output voltage waveforms for the charge control with and without the IVF control are shown in FIG. 29. The upper waveform in FIG. 29 is the converter input voltage ac component which has 30-V_{PP} magnitude. The lower waveforms show converter output voltage V_{O} and its lower-frequency component V_{O_LF}. Without the IVF control, the output voltage waveform and its low frequency component in FIG. 29 have 38-m V_{PP} and 13-m V_{PP} ripple, respectively. With the IVF control added, the output voltage waveform and its low frequency component have their ripple reduced to 30-m V_{PP} and 0.64-m V_{PP}, respectively. Therefore, the addition of the IVF control reduces the magnitude of the output voltage low frequency component 20.3 times.

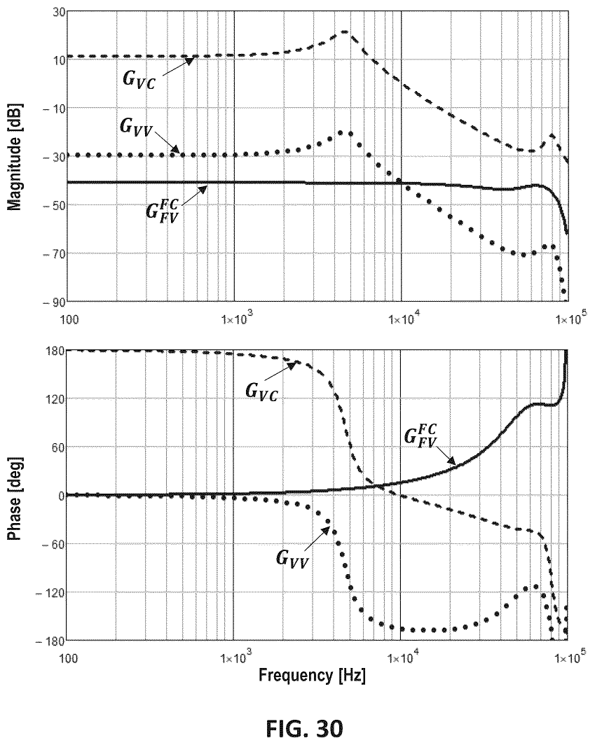

When the IVF control is applied together with the direct frequency control, its ideal transfer function G_{FV}^{FC} is calculated using equation (2). The Bode plots of transfer functions G_{VC}, G_{VV}, and G_{FV}^{FC} of the full-bridge LLC converter with the DFC are shown in FIG. 30. At low frequencies, transfer function G_{FV}^{FC} can be successfully approximated with its dc gain. For example, the G_{FV}^{FC} magnitude deviates from its dc value by 3 dB at 77.5-kHz frequency, whereas the G_{FV}^{FC} phase deviates from zero by 45° at 26.4-kHz frequency.

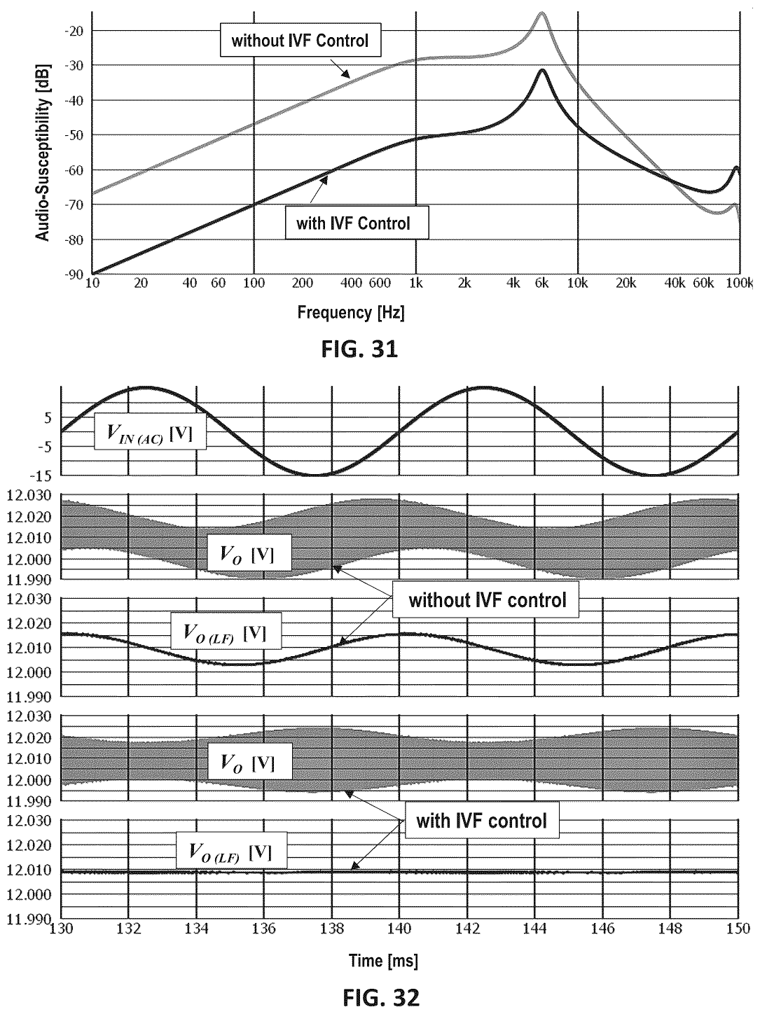

For the DFC with transfer function G_{FV}^{FC} approximated by its dc gain, the Bode plots of closed-loop audio-susceptibility G_{VV}^{CL} of the full-bridge LLC converter with and without the IVF control were calculated from (1) and are shown in FIG. 31. According to FIG. 31, addition of the IVF control to the DFC reduces the audio-susceptibility by 23 dB from −47 dB to −70 dB at 100-Hz frequency. Simulated input and output voltage waveforms for the DFC with and without the IVF control are shown in FIG. 32. The upper waveform in FIG. 32 is the converter input voltage ac component which has 30-V_{PP} magnitude. The lower waveforms show the converter output voltage V_{O} and its lower-frequency component V_{O_LF}. Without the IVF control, the output voltage low frequency component in FIG. 32 has 49-m V_{PP} magnitude. With the IVF control added, the output voltage low frequency component is reduced to −8.4-m V_{PP}, respectively. Therefore, the addition of the IVF control reduces the magnitude of the output voltage low frequency component 5.8 times. Hence, the presented data confirms that addition of the IVF control to the charge control has more performance benefits than addition of the IVF control to the direct frequency control.

Therefore, the combined charge and feedforward controls disclosed herein have significantly better performance with respect to the combined direct frequency and feedforward controls.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical value appearing in the present disclosure are deemed modified by a term of degree (e.g., “about”), thereby reflecting its intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

What is claimed is:

1. An isolated DC-DC converter, comprising:
a full-bridge switching stage having a plurality of active switches;
a resonant network having a plurality of resonant components;
a transformer connected to the resonant network;
an output stage connected to the transformer and configured to generate an output signal, wherein the output signal is an output voltage or output current;
an error amplifier configured to generate an error signal based on the output signal and a reference signal, wherein the reference signal is a reference voltage or reference current;
a feedforward controller configured to sense an input voltage of the full bridge switching stage, and generate a feedforward control signal based on the sensed signal;
a charge sensor connected to the resonant network or the full-bridge switching stage and configured to generate at least one charge sensing signal; and
a switch controller configured to generate and provide switch control signals to the plurality of active switches in charge control mode based on at least the error signal, the feedforward control signal and the charge sensing signal.

2. The isolated DC-DC converter of claim 1, wherein an output of the feedforward controller and the error signal of the error amplifier are combined to generate a combined signal, and the feedforward control signal is generated based on the combined signal and the charge sensing signal.

3. The isolated DC-DC converter of claim 2, wherein the feedforward control signal is generated based on the combined signal, and the switch control signals are generated based on the feedforward control signal and the charge sensing signal.

4. The isolated DC-DC converter of claim 3, wherein the feedforward controller comprises a voltage feedforward controller configured to sense the input voltage of the full bridge switching stage and produce a voltage feedforward output.

5. The isolated DC-DC converter of claim 4, wherein the error signal is a voltage error signal, and the combined signal is generated by subtracting the voltage feedforward output from the error signal.

6. The isolated DC-DC converter of claim 4, wherein the feedforward controller further comprises a current feedforward controller configured to sense the output current of the output stage and produce a current feedforward output.

7. The isolated DC-DC converter of claim 6, wherein the error signal is a current error signal, wherein the combined signal is generated by summing the current feedforward output with the error signal.

8. The isolated DC-DC converter of claim 7, wherein the feedforward control signal is generated based on the combined signal and the voltage feedforward output.

9. The isolated DC-DC converter of claim 1, wherein the at least one charge sensing signal corresponds to at least one of the following: one of the plurality of resonant components, the plurality of active switches, the full-bridge switching stage.

10. The isolated DC-DC converter of claim 9, wherein the plurality of resonant components comprise at least a resonant inductor and a resonant capacitor, and the charge sensing signal corresponds to the resonant inductor or the resonant capacitor.

11. The isolated DC-DC converter of claim 10, wherein the charge sensing signal corresponds to an inductor current flowing through the resonant inductor or a capacitor voltage across the resonant capacitor.

12. The isolated DC-DC converter of claim 10, wherein the charge sensor is implemented as a voltage transformer, a current transformer or sensing winding of a resonant magnetic component.

13. The isolated DC-DC converter of claim 12, wherein the charge sensor is implemented as the sensing winding of the resonant magnetic component and is configured to generate the charge sensing signal corresponding to a voltage across the sensing winding.

14. The isolated DC-DC converter of claim 12, wherein the charge sensor is implemented as the current transformer and is configured to generate the charge sensing signal corresponding to a current of the resonant inductor.

15. The isolated DC-DC converter of claim 12, wherein the charge sensor is implemented as the voltage transformer and is configured to generate the charge sensing signal corresponding to a voltage across one of the resonant capacitors.

16. The isolated DC-DC converter of claim 9, wherein the charge sensor is configured to generate a plurality of said charge sensing signals corresponding to currents flowing through branches of the full-bridge switching stage.
